(19) United States
(12) Patent Application Publication
(10) Pub. No.: US 2024/0388495 A1
(43) Pub. Date: Nov. 21, 2024

(54) RAPID INCIDENT MANAGEMENT SYSTEM

(71) Applicant: Microsoft Technology Licensing, LLC, Redmond, WA (US)

(72) Inventors: Zhongkai LIU, Redmond, WA (US); Lavaleen K. Jha, Bothell, WA (US)

(21) Appl. No.: 18/317,519

(22) Filed: May 15, 2023

(51) Int. Cl. H04L 41/0604; G06F 40/242; G06F 40/284; H04L 41/0686

(52) U.S. Cl. CPC H04L 41/0604; G06F 40/242; G06F 40/284; H04L 41/0686

(57) ABSTRACT

Example aspects include techniques for implementing a rapid incident management system. These techniques include determining coverage information indicating a relationship between an incident and a plurality of incident assignment groups, and determining a plurality of incident features based on the coverage information and an incident description corresponding to the incident. In addition, the techniques include generating assignment likelihood information for each of the plurality of incident assignment groups based on the plurality of incident features, assigning the incident to an incident assignment group having a highest assignment likelihood value within the assignment likelihood information, and transmitting a notification to a device associated with the incident assignment group.

### BACKGROUND

Incident management is a process used to respond to and address unplanned events that can affect service quality or service operations. Incident management aims to identify and correct problems while maintaining normal service and minimizing impact to computing operations. Typically, incident management is performed via a manual process where human operators manually analyze incident information and route the incident based on domain expertise to a related group for the mitigation, or an automated process where incidents are programmatically routed to a related group for mitigation. However, both approaches have proven to be slow, inefficient, error-prone, and non-scalable. Further, automated approaches often require training data that may not be initially available to configure an automated process for incident routing.

For instance, cloud computing systems may be composed of multiple processes, layers, and/or services. As an example, a cloud computing system may include a compute service, a storage service, a virtualization service, and a network service that combine to provide one or more applications. Due to the interdependency among the services, incidents within a service may be related to or resulting from issues arising within one or more other services, which may complicate the process of determining the responsible group to assign an incident for mitigation. As a result, incidents may be transferred between multiple groups before arriving at the responsible group or require significant review before assignment, thereby increasing the time to mitigate, prolonging potential service level agreement (SLA) breaches, and/or negatively impacting customer experience.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a device including: a memory storing instructions; and at least one processor coupled with the memory and configured to execute the instructions to: determine coverage information indicating a relationship between an incident and a plurality of incident assignment groups; determine a plurality of incident features based on the coverage information and an incident description corresponding to the incident; generate assignment likelihood information for each of the plurality of incident assignment groups based on the plurality of incident features; assign the incident to an incident assignment group of the plurality of incident assignment groups having a highest assignment likelihood value within the assignment likelihood information; and transmit a notification to a device associated with the incident assignment group.

In some aspects, the techniques described herein relate to a method including: determining coverage information indicating a relationship between an incident and a plurality of incident assignment groups; determining a plurality of incident features based on the coverage information and an incident description corresponding to the incident; generating assignment likelihood information for each of the plurality of incident assignment groups based on the plurality of incident features; assigning the incident to an incident assignment group of the plurality of incident assignment groups having a highest assignment likelihood value within the assignment likelihood information; and transmitting a notification to a device associated with the incident assignment group.

In some aspects, the techniques described herein relate to a non-transitory computer-readable device having instructions thereon that, when executed by at least one computing device, causes the at least one computing device to perform operations including: determining coverage information indicating a relationship between an incident and a plurality of incident assignment groups; determining a plurality of incident features based on the coverage information and an incident description corresponding to the incident; generating assignment likelihood information for each of the plurality of incident assignment groups based on the plurality of incident features; assigning the incident to an incident assignment group of the plurality of incident assignment groups having a highest assignment likelihood value within the assignment likelihood information; and transmitting a notification to a device associated with the incident assignment group.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example of a cloud computing system, in accordance with some aspects of the present disclosure.

FIG. 2 illustrates an example of a keyword feature module within the cloud computing system, in accordance with some aspects of the present disclosure.

FIG. 3 illustrates an example of a machine learning (ML) model within the cloud computing system, in accordance with some aspects of the present disclosure.

FIG. 4 is a flow diagram illustrating an example method for employing rapid incident management system, in accordance with some aspects of the present disclosure.

FIG. 5 is a block diagram illustrating an example of a hardware implementation for a cloud computing device, in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for implementing a rapid incident management system. In particular, aspects of the present disclosure provide a system configured to perform an assignment process that combines a knowledge-based technique of incident management and a ML technique of incident management to implement a hybrid approach that is accurate, efficient, and scalable. Accordingly, for example, a cloud service provider may employ the assignment process to provide a scalable incident routing method that significantly reduces time to engage and time to mitigate in comparison to conventional methods.

In modern computing environments, incident management is a largely inefficient process due to the large number of users, services, dependencies, and engineers involved. For example, due to the number of services in a modern cloud environment, conventional incident management techniques often result in an untimely review period before an issue ticket is transferred to the correct service or an issue ticket being transferred between multiple service teams before the correct service team is identified. In accordance with some aspects of the present disclosure, an assignment module is configured to leverage domain knowledge and ML to identify the correct service group for an incident. Accordingly, the systems, devices, and methods described herein provide techniques for performing speedy and accurate incident routing to drastically reduce time to engage and expedite issue mitigation.

### Illustrative Environment

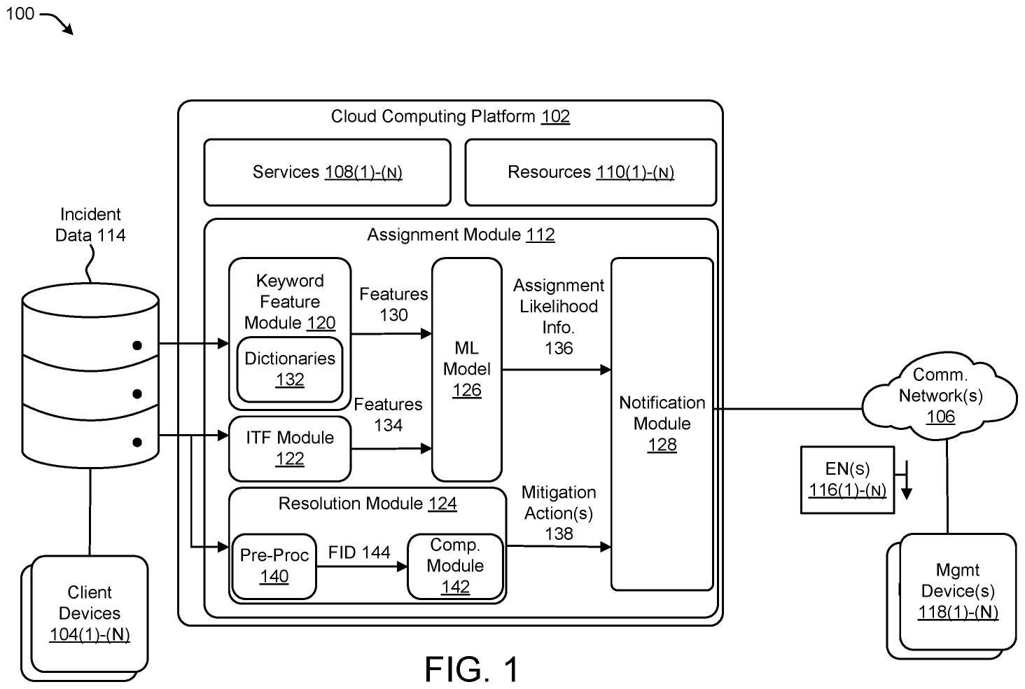

FIG. 1 is a diagram showing an example of a cloud computing system 100, in accordance with some aspects of the present disclosure.

As illustrated in FIG. 1, the cloud computing system 100 includes a cloud computing platform 102, and a plurality of client devices 104(1)-(n). The cloud computing platform 102 may provide the client devices 104(1)-(n) with distributed storage and access to software, services, files, and/or data via a communications network 106, e.g., the Internet, intranet, etc. Some examples of the client devices 104(1)-(n) include smartphone devices and computing devices, Internet of Things (IoT) devices, drones, robots, process automation equipment, sensors, control devices, vehicles, transportation equipment, tactile interaction equipment, virtual and augmented reality (VR and AR) devices, industrial machines, etc. Further, in some aspects, a client device 104 includes one or more applications configured to interface with the cloud computing platform 102.

As illustrated in FIG. 1, the cloud computing platform 102 may further include a plurality of services 108(1)-(n), a plurality of resources 110(1)-(n), and an assignment module 112. Some examples of a service include infrastructure as a service (IaaS), platform as a service (PaaS), software as a service (SaaS), database as a service (DaaS), security as a service (SECaaS, big data as a service (BDaaS), a monitoring as a service (MaaS), logging as a service (LaaS), internet of things as a service (IOTaaS), identity as a service (IDaaS), analytics as a service (AaaS), function as a service (FaaS), and/or coding as a service (CaaS). Further, each service 108 may be associated with one or more service level agreements (SLAs) defining a level of service provided by a service 108 to a client device 104 or a plurality of the client devices 104. As described herein, a “SLA” may refer to a contract between the provider of a service (e.g., the cloud computing platform 102) and a customer that defines which services the provider will offer and the level of performance the services must meet as well as any remedies or penalties should the agreed-upon levels not be realized. In some aspects, SLAs typically establish customer expectations for a provider's performance and quality. In some examples, the level of service includes a performance guarantee and/or availability guarantee. Some examples of the resources 110(1)-(n) may include computing units, bandwidth, data storage, application gateways, software load balancers, memory, field programmable gate arrays (FPGAs), graphics processing units (GPUS), input-output (I/O) throughput, or data/instruction cache. As described in detail herein, the resources 110(1)-(n) may be reserved for use by the services 108(1)-(n).

As described in detail herein, incidents may occur on the cloud computing platform 102 and affect one or more services 108 and/or resources 110(1)-(n). For example, one or more components of a service 108 may suffer a temporary outage due to an unknown cause. As another example, a user may encounter an exception or bug during use of a SaaS instance. As yet still another example, a user may require technical support during use of a service 108 and/or resource 110. Further, the incidents may significantly diminish the ability of the cloud computing platform 102 to provide satisfactory reliability and/or user experience, meet the SLAs, and/or avoid cause costly downtime of one or more services 108. Additionally, or alternatively, in some aspects, incidents may occur on the client devices 104(1)-(n). For example, a user may encounter an exception or bug during use of a client application on a client device 104. As such, as described herein, the cloud computing platform 102 may be configured to minimize the time to mitigate (TTM) an incident. As used herein, the TTM may include the time to detect (TTD) (i.e., the time from the start of an incident's impact on a service/resources/client device/client application to the time that the incident is visible to the cloud computing platform 102), time to engage (TTE) (i.e., time from detection of the incident until the time the appropriate engineer and/or repair component is engaged with the incident), and time to fix (TTF) (i.e., the time that it takes a responder to mitigate the incident).

The assignment module 112 may be configured to monitor incident data 114 received from the client devices 104 and assign an incident within the incident data 114 to an incident assignment group via a collaborative approach that employs knowledge-based analysis and ML to significantly reduce TTE in comparison to conventional approaches. In some aspects, incident data 114 includes an incident identifier, a short description of the incident, and a detailed description of an incident. In some aspects, the incident data 114 for an incident may further include one or more resource identifiers each associated with a resource 110 affected by the incident, a type of resource affected by the incident, and/or an incident information (e.g., an identifier of a symptom of the incident, an identifier of one or more regions, datacenters, and/or clusters affected by the incident). Some examples of a resource type include virtual machine, storage, application gateway, software load balancer, etc. Further, the incident data 114 of an incident includes a health status of the corresponding service 108 and/or a component of the corresponding service 108, and dependency information identifying one or more related services 108 of the corresponding service 108. Some examples of the health status include healthy, unhealthy, degraded, and unknown.

As used herein, in some aspects, an incident assignment group may be a group tasked with resolving an incident. Further, in some aspects, each assignment group may be associated with a different type of service, resource, technology area, organization, department, support group, functional component, account, user, location, etc. For example, in a customer relations management (CRM)/business intelligence (BI) context (e.g., enterprise resource planning application), there may be individual incident assignment groups for incidents that should be managed by a finance department, a supply chain department, a human capital management department, a BI department, a security department, and a technical department. In some instances, an incident assignment group includes engineers, technical support personnel, and/or analysts assigned mitigation responsibilities or mitigation agents configured to manage an incident (e.g., repair a resource 110 or a service 108) via an auto-mitigation technique. Further, in some aspects, the assignment module 112 assigns an incident to an incident assignment group by transmitting an engagement notification 116 corresponding to an incident to one or more management devices 118(1)-(n) associated with the incident assignment group. Some examples of the management devices 118(1)-(n) include smartphone devices and computing devices, Internet of Things (IoT) devices, drones, robots, process automation equipment, sensors, control devices, vehicles, transportation equipment, tactile interaction equipment, virtual and augmented reality (VR and AR) devices, industrial machines, etc. Further, in some aspects, a client device 104 includes one or more applications configured to interface with the cloud computing platform 102.

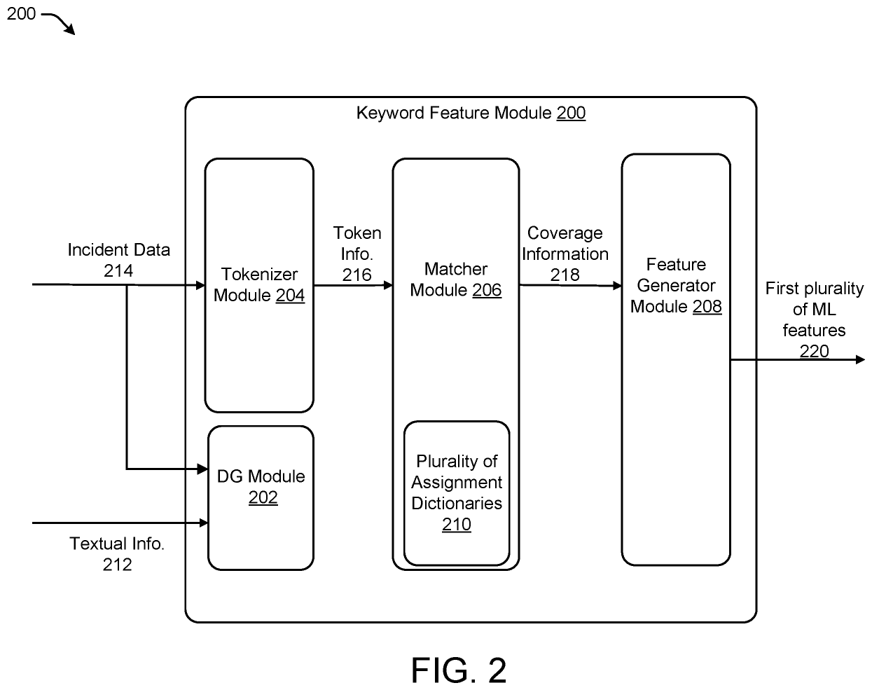

As illustrated in FIG. 1, the assignment module 112 includes a keyword feature module 120, an incident text feature (ITF) module 122, a resolution module 124, one or more ML models 126, and a notification module 128. As described herein, the keyword feature module 120 performs a knowledge-based analysis of the incident data 114 corresponding to an incident to calculate coverage information. Further, the keyword feature module 120 determines a first plurality of ML features 130 based on coverage information. As described in further detail with respect to FIG. 2, the keyword feature module 120 determines the coverage information by identifying a plurality of tokens within the incident data 114, compares the plurality of tokens to a plurality of incident assignment group dictionaries 132 to calculate count information indicating the presence of the plurality of tokens in the individual dictionaries, and generates the coverage information using the count information for the plurality of incident assignment group dictionaries 132. As used herein, in some aspects, a token refers to words, characters, symbols, or sub-words. Further, the keyword feature module 120 generates the first plurality of ML features 130 based on formatting the coverage information for input into the one or more ML models 126.

Additionally, the ITF module 122 generates a second plurality of ML features 134 based on the incident data 114 corresponding to an incident. For example, in some aspects, the ITF module 122 performs a hash operation on at least a short description of an incident and a detailed description of the incident to generate the second plurality of ML features 134. In some aspects, the second plurality of ML features 134 are a numerical representation of the incident data 114 for an incident that can be input into the one or more ML models 126.

Further, as described herein, in some aspects, the one or more models 126 are trained and configured to recommend an incident assignment group for resolving an incident based on the first plurality of ML features 130 and the second plurality of ML features 134 associated with the incident. For example, as illustrated in FIG. 1, in some aspects, the one or more ML models 126 receive the first plurality of ML features 130 and the second plurality of ML features 134 of an incident, and generate assignment likelihood information 136 identifying an incident assignment group to assign responsibility for mitigating the incident. For instance, in some aspects, the assignment module 112 assigns an incident to the incident assignment group having the highest likelihood value of being the incident assignment group responsible for managing the incident within the assignment likelihood information.

In some aspects, the one or more ML models 126 include neural networks, deep learning models, natural language processing, statistical correlation analysis, pattern recognition algorithms, and/or any other type of ML/AI model. Further, as described herein, in some aspects, employing the keyword feature module 120 with the one or more ML models 126 reduces TTE while improving accuracy of incident assignment. As such, incident handling within the cloud computing platform 102 may be optimized for use by a large scale cloud service provider as the assignment module 112 is configured for scalability and can handle large volumes of incidents.

In some aspects, the one or more ML models 126 include a convolutional neural network (CNN). In some aspects, a “neural network” may refer to a mathematical structure taking an object as input and producing another object as output through a set of linear and non-linear operations called layers. Such structures may have parameters which may be tuned through a learning phase so as to produce a particular output. Further, a “convolutional neural network” may refer to a neural network which is partly composed of convolutional layers, i.e., layers which apply a convolution on their input. In some aspects, as used herein, a “convolution” may refer to a linear operation that involves the multiplication of a set of weights with the input, much like a traditional neural network. Additionally, in some aspects, the multiplication may be performed between an array of input data and a two-dimensional array of weights, called a filter or a kernel. In some examples, each filter may be a collection of kernels, with there being one kernel for every single input channel to the layer, and each kernel being unique. Unlike a standard neural network, layers of a CNN are arranged in a 3D volume in three dimensions: width, height, and depth (where depth refers to the third dimension of the volume, such as the number of channels in an image or the number of filters in a layer). Examples of the different layers of a CNN includes one or more convolutional layers, non-linear operator layers (such as rectified linear units (ReLU) functions, sigmoid functions, or hyperbolic tangent functions), pooling or subsampling layers, fully connected layers, and/or final loss layers. Each layer may connect one upstream layer and one downstream layer. The input may be considered as an input layer, and the output may be considered as the final output layer.

Further, in some aspects, the first plurality of ML features 130 and the second plurality of ML features 134 are tensors input to the one or more ML models 126 (e.g., a CNN). As used herein, a “tensor” may refer to a generalization of vectors and matrices to potentially higher dimensions. In some aspects, a tensor may be a data structure organized as an array of numbers. The tensor may be characterized by a degree or order of the tensor. A zeroth-order tensor is a scalar, a first-order tensor is a vector (i.e., a one-dimensional array), a second-order tensor is a two-dimensional array, and so forth. Each dimension of the tensor can have a different respective number of elements or values.

Further, the resolution module 124 recommends mitigation actions 138(1)-(n) for the incidents within the incident data 114. For example, in response to input of incident text for an incident corresponding to network inaccessibility, the resolution module 124 recommends re-routing network traffic via an alternative route. As another example, a user may report that a service 108 is unresponsive, and the resolution module 124 may recommend restarting the service with modified configuration parameters. As illustrated in FIG. 1, the resolution module 124 includes a pre-processor 140 and a comparison module 142. In some aspects, the pre-processor 140 formats the incident data 114 to generate formatted incident data 144. In some aspects, the pre-processor 140 removes punctuation and special characters from the incident description, removes numerical values from the incident description, applies a uniform case to the text of the incident description, removes a group of stop words from the incident description, and/or removes one or more whitespaces from the incident description.

Further, in some aspects, the comparison module 142 compares the formatted incident data to historic incident information, and recommends a mitigation action 138 employed to resolve a historic incident having incident text that matches the incident text of the incident. For instance, in some aspects, the comparison module 140 employs correlation analysis (e.g., a cosine similarity process) to identify that the incident data 114 of a current incident has a correlation value above a predefined threshold with incident data 114 for one or more historic incidents, determines a previously-employed mitigation action 138 in response to the one or more historic incidents, and recommends the previously-employed mitigation action 138 action as a current mitigation action 138 for the current incident. As an example, the comparison module 142 may determine that formatted incident data 144 for a current incident matches historic formatted incident data 144, identify that network traffic was re-routed as a solution to the one or more incidents associated with the historic formatted incident data 144, and recommend re-routing network traffic as the mitigation action 138 for the incident.

Further, in some aspects, the notification module 128 transmits engagement notifications 116(1)-(n) to the management devices 118(1)-(n). For example, in response to the ML model 126 identifying that an incident assignment group should be assigned an incident, the notification module 128 transmits an engagement notification (EN) 116 to one or more management devices 118 associated with the incident assignment group. In addition, the engagement notification 116 indicates that the incident assignment group has been assigned responsibility for managing the incident, and includes a description of the incident (e.g., a detailed description of the incident). Additionally, in some aspects, the engagement notification 116 for an incident includes a corresponding mitigation action determined by the resolution module 124. Additionally, in some aspects, a management device 118 is configured to present a graphical user interface (GUI) displaying incident information and/or mitigation information based on the engagement notifications 116(1)-(n). For example, in some aspects, a management device 118 generates a GUI displaying incident data 114 for an incident and a mitigation action 138 for the incident based on the content of a engagement notification 116.

FIG. 2 illustrates an example of a keyword feature module 200 (e.g., keyword feature module 120) within a cloud computing system, in accordance with some aspects of the present disclosure. As illustrated in FIG. 2, in some aspects, a keyword feature module 200 includes a dictionary generation module 202, a tokenizer module 204, a matcher module 206, and a feature generator module 208.

In some aspects, the dictionary generation module 202 generates a plurality of assignment dictionaries 210 (e.g., the plurality of incident assignment group dictionaries 132). As used herein, in some aspects, an “assignment dictionary” refers to a collection of terms associated with an incident assignment group. In some examples, the dictionary generation module 202 generates the plurality of assignment dictionaries 210 based on textual information corresponding to the different assignment groups. For example, in some aspects, the dictionary generation module 202 formats textual information 212 (e.g., a troubleshooting guide, user-generated information, etc.) associated with an incident assignment group to generate formatted assignment group information, and generates a dictionary for the incident assignment group based upon the formatted assignment group information. In some examples, the formatting process include removing punctuation, numerical values, stop words, and/or whitespaces, and applying a uniform case to the textual information 212 of a particular group to generate the formatted assignment group information for a particular assignment group. Further, in some aspects, the dictionary generation module 202 extracts a plurality of n-grams from the formatted assignment group information as the terms of the assignment dictionary 210 for the particular assignment group.

In some aspects, the dictionary generation module 202 employs machine learning, natural language processing, and/or pattern recognition to determine that a term belongs in an assignment dictionary 210 for an incident assignment group. For example, in some aspects, the dictionary generation module 202 determines that a term belongs within the assignment dictionary 210 for an incident assignment group based at least in part on determining via a ML model that the term has a relevance value above a predefined threshold to the incident assignment group.

In some aspects, the tokenizer module 204 formats incident data 214 to generate token information 216 for each incident. For example, in some aspects, the tokenizer module 204 formats incident data 214 associated with a particular incident to generate formatted incident data, and identifies a plurality of tokens within the formatted incident data to generate the token information 216. In some examples, the formatting process include removing punctuation, numerical values, stop words, and/or whitespaces, and applying a uniform case to the formatted incident data for a particular incident.

Further, the matcher module 206 compares the token information 216 for each incident to the plurality of assignment dictionaries 210 to determine coverage information 218. In some aspects, the coverage information 218 for a particular incident includes count information for each assignment group. As described herein, the matcher module 206 determines count information for each assignment group by identifying the number of tokens within the token information 216 of an incident that are present within the assignment dictionary 210 corresponding to the incident assignment group. Further, the feature generator module 208 generates a plurality of ML features 220 (e.g., the plurality of ML features 130) based on formatting the coverage information 218 for input into an ML model (e.g., the one or more ML models 126). As an example, in some aspects, the feature generator module 208 generates a tensor representation, vector representation, or other form of numerical representation of the coverage information 218 for input into an ML model (e.g., the ML model, the ML model 300, etc.).

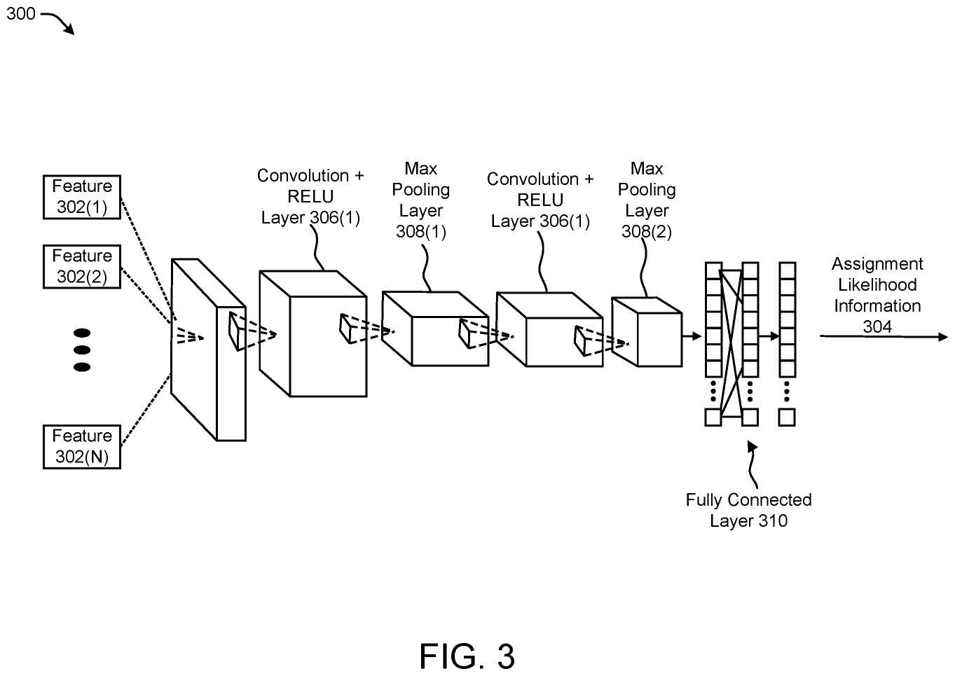

FIG. 3 illustrates an example of a ML model 300 within the cloud computing system, in accordance with some aspects of the present disclosure. As illustrated in FIG. 3, the ML model 300 receives a plurality of ML features 302(1)-(n) of an incident and generates assignment likelihood information 304 based on the plurality of ML features 302(1)-(n). As described herein, the plurality of ML features 302 include a plurality of ML features generated by a keyword feature module (e.g., the keyword feature module 120) and an ITF module (e.g., the ITF module 122) for an incident, and the assignment likelihood information 304 identifies an incident assignment group that can be assigned responsibility for managing resolution of the incident.

As illustrated in FIG. 3, the ML model 300 includes a first convolution+ReLU layer 306(1), a first max pooling layer 308(1), a second convolution+ReLU layer 306(2), a second max pooling layer 308(2), and a fully connected layer 310. In some aspects, the first convolution+ReLU layer 306(1), the first max pooling layer 308(1), the second convolution +ReLU layer 306(2), and the second max pooling layer 308(2) are trained to perform feature learning functions within the ML model 300, while the fully connected layer 310 is trained to perform a classification function based on the output of the second max pooling layer 306(2) to generate assignment likelihood information 304 for a particular incident. Although FIG. 1 shows two convolution+RELU layers, in some aspects the ML model 300 may include any number of convolution and/or ReLU layers.

### Example Process

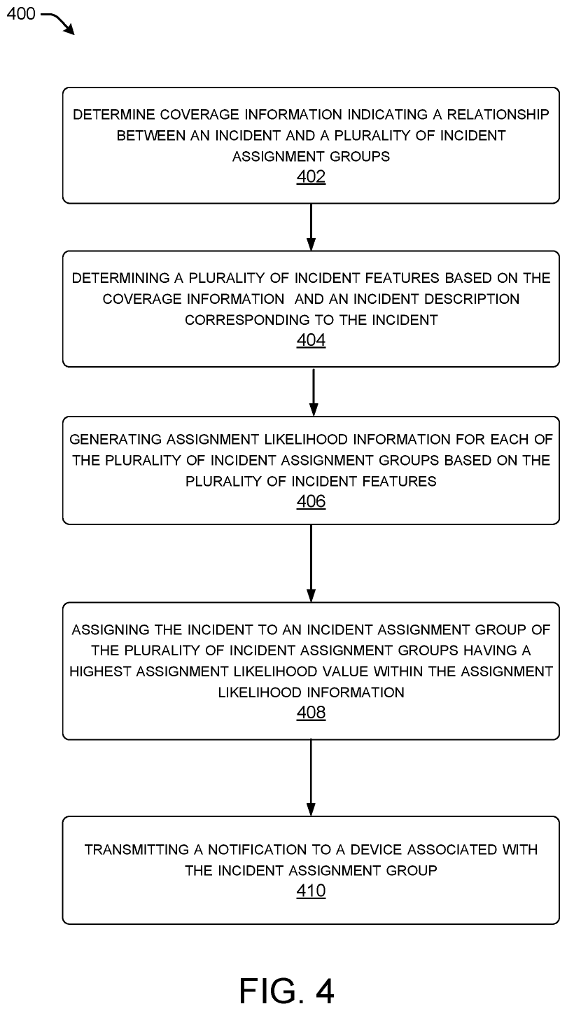

The described processes in FIG. 4 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the cloud computing platform 102. By way of example and not limitation, the method 400 is described in the context of FIGS. 1-3 and 5. For example, the operations may be performed by one or more of the assignment module 112, the keyword feature module 120, the ITF module 122, the resolution module 124, the one or more ML models 126, the notification module 128, the keyword feature module 200, the dictionary generation module 202, the tokenizer module 204, the matcher module 206, the feature generator module 208, the ML model 300, the first convolution+ReLU layer 306(1), the first max pooling layer 308(1), the second convolution+ReLU layer 306(2), the second max pooling layer 308(2), and the fully connected layer 310.

FIG. 4 is a flow diagram illustrating an example method 400 for implementing a rapid incident management process, in accordance with some aspects of the present disclosure.

At block 402, the method 400 may include determining coverage information indicating a relationship between an incident and a plurality of incident assignment groups. For example, a client device 104 may submit incident data 214 corresponding to an incident affecting a service 108 and/or resource 110. Further, in some aspects, the tokenizer module 204 generates token information 216 based on the incident data 214, and the matcher module 206 determines coverage information 218 for the incident data 214 based on comparing the token information 216 to the plurality of assignment dictionaries 210. As described herein, in some aspects, the coverage information 218 includes numerical values identifying the number of tokens within the token information 216 present within each of the plurality of assignment dictionaries 210.

Accordingly, the cloud computing platform 102, the cloud computing device 500, and/or the processor 502 executing the assignment module 112, the keyword feature module 120, the keyword feature module 200, and/or the matcher module 206 may provide means for determining coverage information indicating a relationship between an incident and a plurality of incident assignment groups.

At block 404, the method 400 may include determining a plurality of incident features based on the coverage information and an incident description corresponding to the incident. For example, the feature generator module 208 generates the first plurality of ML features 220 for input into the ML model 300 based on the coverage information 218, and the ITF module 122 generates the second plurality of ML features 134 based on the incident data 214.

Accordingly, the cloud computing platform 102, the cloud computing device 500, and/or the processor 502 executing the assignment module 112, ITF module 122, the keyword feature module 200, and/or the feature generator module 208 may provide means for determining a plurality of incident features based on the coverage information and an incident description corresponding to the incident.

At block 406, the method 400 may include generating assignment likelihood information for each of the plurality of incident assignment groups based on the plurality of incident features. For example, the ML model 300 generates assignment likelihood information 304 indicating the likelihood that the incident corresponds to each of the incident assignment groups. Further, as described herein, in some aspects, the ML model 300 is a CNN that generates the assignment likelihood information 304 based on the first plurality of ML features 220 and the second plurality of ML features 134

Accordingly, the cloud computing platform 102, the cloud computing device 500, and/or the processor 502 executing the assignment module 112, the one or more ML models, the ML model 300, and/or the fully connected layer 310 may provide means for generating assignment likelihood information for each of the plurality of incident assignment groups based on the plurality of incident features.

At block 408, the method 400 may include assigning the incident to an incident assignment group of the plurality of incident assignment groups having a highest assignment likelihood value within the assignment likelihood information. For example, the assignment module 112 assigns an incident to an incident assignment group based at least in part on the incident assignment group having the highest likelihood within the assignment likelihood information 304.

Accordingly, the cloud computing platform 102, the cloud computing device 500, and/or the processor 502 executing the assignment module 112 may provide means for assigning the incident to an incident assignment group of the plurality of incident assignment groups having a highest assignment likelihood value within the assignment likelihood information.

At block 410, the method 400 may include transmitting a notification to a device associated with the incident assignment group. For example, in some aspects, the notification module 128 generates an engagement notification 116 indicating assignment of an incident to an incident assignment group, and transmits the engagement notification 116 to one or more management devices 118 associated with the incident assignment group.

Accordingly, the cloud computing platform 102, the cloud computing device 500, and/or the processor 502 executing the assignment module 112 and/or the notification module 128 may provide means for transmitting a notification to a device associated with the incident assignment group.

In additional aspect, the method 400 includes wherein determining the coverage information indicating the relationship between the incident and the plurality of incident assignment groups includes: determining the coverage information based on performing keyword matching over the incident description. Accordingly, the cloud computing platform 102, the cloud computing device 500, and/or the processor 502 executing the assignment module 112, the keyword feature module 120, the keyword feature module 200, and/or the matcher module 206 may provide means for determining the coverage information based on performing keyword matching over the incident description.

In additional aspect, the method 400 includes wherein determining the coverage information indicating the relationship between the incident and the plurality of incident assignment groups includes: performing one or more pre-processing steps on the incident description to generate formatted incident information; extracting a plurality of incident tokens from the formatted incident information; counting a number of matches between the plurality of incident tokens and individual assignment dictionaries to determine count information, wherein each assignment dictionary is associated with an incident assignment group of the plurality of incident assignment groups; and calculating the coverage information based on the count information. Accordingly, the cloud computing platform 102, the cloud computing device 500, and/or the processor 502 executing the assignment module 112, the keyword feature module 120, the keyword feature module 200, and/or the matcher module 206 may provide means for performing one or more pre-processing steps on the incident description to generate formatted incident information; extracting a plurality of incident tokens from the formatted incident information; counting a number of matches between the plurality of incident tokens and individual assignment dictionaries to determine count information, wherein each assignment dictionary is associated with an incident assignment group of the plurality of incident assignment groups; and calculating the coverage information based on the count information.

In additional aspect, the method 400 includes wherein to the one or more pre-processing steps include a least one of: removing punctuation from the incident description; removing numerical values from the incident description; applying a common case to the incident description; removing one or more stop words from the incident description; or removing one or more whitespaces from the incident description. Accordingly, the cloud computing platform 102, the cloud computing device 500, and/or the processor 502 executing the assignment module 112, the keyword feature module 120, the keyword feature module 200, and/or the matcher module 206 may provide means for removing punctuation from the incident description; removing numerical values from the incident description; applying a common case to the incident description; removing one or more stop words from the incident description; or removing one or more whitespaces from the incident description

In additional aspect, the method 400 includes wherein determining the plurality of incident features based on the incident description and the coverage information, includes: generating one or more features of the plurality of incident features based on hashing the incident description to generate a numerical representation of the incident description as one or more features of the plurality of incident features. Accordingly, the cloud computing platform 102, the cloud computing device 500, and/or the processor 502 executing the assignment module 112, and/or the ITF module 122 may provide means for generating one or more features of the plurality of incident features based on hashing the incident description to generate a numerical representation of the incident description as one or more features of the plurality of incident features

In additional aspect, the method 400 includes wherein generating the assignment likelihood information for each of the plurality of incident assignment groups based on the plurality of incident features includes: calculating, via a convolutional neural network, the assignment likelihood information for each of the plurality of incident assignment groups based on the plurality of incident features. Accordingly, the cloud computing platform 102, the cloud computing device 500, and/or the processor 502 executing the assignment module 112, the one or more ML models, the ML model 300, and/or the fully connected layer 310 may provide means for calculating, via a convolutional neural network, the assignment likelihood information for each of the plurality of incident assignment groups based on the plurality of incident features.

In additional aspect, the method 400 includes wherein the notification further includes a mitigation action. Accordingly, the cloud computing platform 102, the cloud computing device 500, and/or the processor 502 executing the assignment module 112, and/or the notification module 128 may provide means for wherein the notification further includes a mitigation action. In additional aspect, the method 400 includes wherein the incident is a current incident, the incident description is a current incident description, and further including: comparing the current incident description to a historical incident description corresponding to a historical incident to determine a similarity value; and identifying the mitigation action based on the mitigation action being applied to the historical incident and the similarity value being greater than a predefined threshold. Accordingly, the cloud computing platform 102, the cloud computing device 500, and/or the processor 502 executing the assignment module 112, and/or the resolution module 124 may provide means for comparing the current incident description to a historical incident description corresponding to a historical incident to determine a similarity value; and identifying the mitigation action based on the mitigation action being applied to the historical incident and the similarity value being greater than a predefined threshold.

While the operations are described as being implemented by one or more computing devices, in other examples various systems of computing devices may be employed. For instance, a system of multiple devices may be used to perform any of the operations noted above in conjunction with each other. For example, a car with an internal computing device along with a mobile computing device may be employed in conjunction to perform these operations.

### Illustrative Computing Device

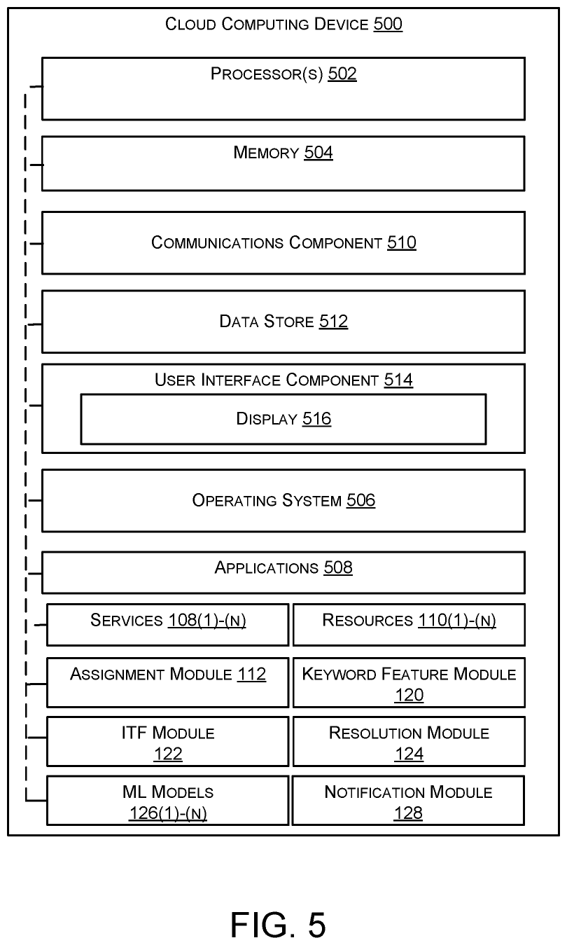

Referring now to FIG. 5, a cloud computing device 500 (e.g., cloud computing platform 102) in accordance with an implementation includes additional component details as compared to FIG. 1. In one example, the cloud computing device 500 includes the processor 502 for carrying out processing functions associated with one or more of components and functions described herein. The processor 502 can include a single or multiple set of processors or multi-core processors. Moreover, the processor 502 may be implemented as an integrated processing system and/or a distributed processing system. In an example, the processor 502 includes, but is not limited to, any processor specially programmed as described herein, including a controller, microcontroller, a central processing unit (CPU), a graphics processing unit (GPU), an application specific integrated circuit (ASIC), a field programmable gate array (FPGA), a system on chip (SoC), or other programmable logic or state machine. Further, the processor 502 includes other processing components such as one or more arithmetic logic units (ALUs), registers, or control units.

In an example, the cloud computing device 500 also includes the memory 504 for storing instructions executable by the processor 502 for carrying out the functions described herein. The memory 504 may be configured for storing data and/or computer-executable instructions defining and/or associated with the operating system 506, the services 108(1)-(n), the resources 110(1)-(n), the assignment module 112, the keyword feature module 120, the ITF module 122, the resolution module 124, the one or more ML models 126, the notification module 128, one or more applications 508, and the processor 502 may execute the operating system 506, the services 108(1)-(n), the assignment module 112, the keyword feature module 120, ITF module 122, the resolution module 124, the one or more ML models 126, the notification module 128, and/or the one or more applications 508. An example of memory 504 includes, but is not limited to, a type of memory usable by a computer, such as random access memory (RAM), read only memory (ROM), tapes, magnetic discs, optical discs, volatile memory, non-volatile memory, and any combination thereof. In an example, the memory 504 may store local versions of applications being executed by processor 502.

The example cloud computing device 500 also includes a communications component 510 that provides for establishing and maintaining communications with one or more parties utilizing hardware, software, and services as described herein. The communications component 510 may carry communications between components on the cloud computing device 500, as well as between the cloud computing device 500 and external devices, such as devices located across a communications network and/or devices serially or locally connected to the cloud computing device 500. For example, the communications component 510 includes one or more buses, and may further include transmit chain components and receive chain components associated with a transmitter and receiver, respectively, operable for interfacing with external devices. In an implementation, for example, the communications component 510 includes a connection to communicatively couple the client devices 104 (1)-(N) and/or the management devices 118(1)-(n) to the processor 502.

The example cloud computing device 500 also includes a data store 512, which may be any suitable combination of hardware and/or software, that provides for mass storage of information, databases, and programs employed in connection with implementations described herein. For example, the data store 512 may be a data repository for the operating system 506 and/or the applications 508.

The example cloud computing device 500 also includes a user interface component 514 operable to receive inputs from a user of the cloud computing device 500 and further operable to generate outputs for presentation to the user. The user interface component 514 includes one or more input devices, including but not limited to a keyboard, a number pad, a mouse, a touch-sensitive display (e.g., display 516), a digitizer, a navigation key, a function key, a microphone, a voice recognition component, any other mechanism capable of receiving an input from a user, or any combination thereof. Further, the user interface component 514 includes one or more output devices, including but not limited to a display (e.g., display 516), a speaker, a haptic feedback mechanism, a printer, any other mechanism capable of presenting an output to a user, or any combination thereof.

In an implementation, the user interface component 514 may transmit and/or receive messages corresponding to the operation of the operating system 506 and/or the applications 508. In addition, the processor 502 executes the operating system 506 and/or the applications 508, and the memory 504 or the data store 512 may store them.

Further, one or more of the subcomponents of the services 108(1)-(n), the assignment module 112, the keyword feature module 120, the ITF module 122, the resolution module 124, the one or more ML models 126, the notification module 128, may be implemented in one or more of the processor 502, the applications 508, the operating system 506, and/or the user interface component 514 such that the subcomponents of the services 108(1)-(n), the assignment module 112, the keyword feature module 120, the ITF module 122, the resolution module 124, the one or more ML models 126, the notification module 128, are spread out between the components/subcomponents of the cloud computing device 500.

### CONCLUSION

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

1. A device comprising:
a memory storing instructions; and
at least one processor coupled with the memory and configured to execute the instructions to:
determine coverage information indicating a relationship between an incident and a plurality of incident assignment groups at least in part by comparing a plurality of incident tokens within incident data of the incident to a plurality of incident assignment group dictionaries each corresponding to one of the plurality of incident assignment groups;
determine a first plurality of incident features based on formatting the coverage information for input to a machine learning model;
determine a second plurality of incident features based on performing a hash operation on an incident description corresponding to the incident;
provide the first plurality of incident features and the second plurality of incident features as input to one or more machine learning models to obtain an output of assignment likelihood information for each of the plurality of incident assignment groups;
assign the incident to an incident assignment group of the plurality of incident assignment groups having a highest assignment likelihood value within the assignment likelihood information;
compare the current incident description to a historical incident description corresponding to a historical incident to determine a similarity value;
identify a mitigation action based on the mitigation action being applied to the historical incident and the similarity value being greater than a predefined threshold; and
transmit, based on the incident assignment group having the highest assignment likelihood value, a notification of assigning the incident to a device associated with the incident assignment group, wherein the notification identifies the mitigation action.

2. The device of claim 1, wherein to determine the coverage information indicating the relationship between the incident and the plurality of incident assignment groups, the at least one processor is configured to determine the coverage information based on performing keyword matching over the incident description.

3. The device of claim 1, wherein to determine the coverage information indicating the relationship between the incident and the plurality of incident assignment groups, the at least one processor is configured to:
perform one or more pre-processing steps on the incident description to generate formatted incident information; and
extract the plurality of incident tokens from the formatted incident information.

4. The device of claim 3, wherein to the one or more pre-processing steps comprise a least one of:
removing punctuation from the incident description;
removing numerical values from the incident description;
applying a common case to the incident description;
removing one or more stop words from the incident description;
removing one or more special characters from the incident description; or
removing one or more whitespaces from the incident description.

5. (canceled)

6. The device of claim 1, wherein the at least one processor is configured to:
calculate, via a convolutional neural network, the assignment likelihood information for each of the plurality of incident assignment groups based on the first plurality of incident features and the second plurality of incident features.

7-8. (canceled)

9. A method comprising:
determining coverage information indicating a relationship between an incident and a plurality of incident assignment groups at least in part by comparing a plurality of incident tokens within incident data of the incident to a plurality of incident assignment group dictionaries each corresponding to one of the plurality of incident assignment groups;
determining a first plurality of incident features based on formatting the coverage information for input to a machine learning model;
determining a second plurality of incident features based on performing a hash operation on an incident description corresponding to the incident;
providing the first plurality of incident features and the second plurality of incident features as input to one or more machine learning models to obtain an output of assignment likelihood information for each of the plurality of incident assignment groups;
assigning the incident to an incident assignment group of the plurality of incident assignment groups having a highest assignment likelihood value within the assignment likelihood information;
compare the current incident description to a historical incident description corresponding to a historical incident to determine a similarity value;
identify a mitigation action based on the mitigation action being applied to the historical incident and the similarity value being greater than a predefined threshold; and
transmitting, based on the incident assignment group having the highest assignment likelihood value, a notification of assigning the incident to a device associated with the incident assignment group, wherein the notification identifies the mitigation action.

10. The method of claim 9, wherein determining the coverage information indicating the relationship between the incident and the plurality of incident assignment groups comprises:
determining the coverage information based on performing keyword matching over the incident description.

11. The method of claim 9, wherein determining the coverage information indicating the relationship between the incident and the plurality of incident assignment groups comprises:
performing one or more pre-processing steps on the incident description to generate formatted incident information; and
extracting the plurality of incident tokens from the formatted incident information.

12. The method of claim 11, wherein to the one or more pre-processing steps comprise at least one of:
removing punctuation from the incident description;
removing numerical values from the incident description;
applying a common case to the incident description;
removing one or more stop words from the incident description;
removing one or more special characters from the incident description; or
removing one or more whitespaces from the incident description.

13. (canceled)

14. The method of claim 9, further comprising
calculating, via a convolutional neural network, the assignment likelihood information for each of the plurality of incident assignment groups based on the first plurality of incident features and the second plurality of incident features.

15-16. (canceled)

17. A non-transitory computer-readable device having instructions thereon that, when executed by at least one computing device, causes the at least one computing device to perform operations comprising:
determining coverage information indicating a relationship between an incident and a plurality of incident assignment groups at least in part by comparing a plurality of incident tokens within incident data of the incident to a plurality of incident assignment group dictionaries each corresponding to one of the plurality of incident assignment groups;
determining a first plurality of incident features based on formatting the coverage information for input to a machine learning model;
determining a second plurality of incident features based on performing a hash operation on an incident description corresponding to the incident;
providing the first plurality of incident features and the second plurality of incident features as input to one or more machine learning models to obtain an output of assignment likelihood information for each of the plurality of incident assignment groups;
assigning the incident to an incident assignment group of the plurality of incident assignment groups having a highest assignment likelihood value within the assignment likelihood information;
compare the current incident description to a historical incident description corresponding to a historical incident to determine a similarity value;
identify a mitigation action based on the mitigation action being applied to the historical incident and the similarity value being greater than a predefined threshold; and
transmitting, based on the incident assignment group having the highest assignment likelihood value, a notification of assigning the incident to a device associated with the incident assignment group, wherein the notification identifies the mitigation action.

18. The non-transitory computer-readable device of claim 17, wherein determining the coverage information indicating the relationship between the incident and the plurality of incident assignment groups comprises:
performing one or more pre-processing steps on the incident description to generate formatted incident information; and
extracting the plurality of incident tokens from the formatted incident information.

19. (canceled)

20. The non-transitory computer-readable device of claim 17, further comprising
calculating, via a convolutional neural network, the assignment likelihood information for each of the plurality of incident assignment groups based on the first plurality of incident features and the second plurality of incident features.

21. The non-transitory computer-readable device of claim 18, wherein to the one or more pre-processing steps comprise a least one of:
removing punctuation from the incident description;
removing numerical values from the incident description;
applying a common case to the incident description;
removing one or more stop words from the incident description;
removing one or more special characters from the incident description; or
removing one or more whitespaces from the incident description.

22-23. (canceled)
